(19) United States
(12) Patent Application Publication
(10) Pub. No.: US 2010/0124469 A1
(43) Pub. Date: May 20, 2010

(54) Twistlock

(76) Inventors: Dianren Zhang, University Place, WA (US); Jeffrey Todd Hubbell, Roy, WA (US)

Correspondence Address: MARK S. HUBERT P.C., 516 SE MORRISON- SUITE 1200, PORTLAND, OR, 97214, US

(21) Appl. No.: 12/454,225

(22) Filed: May 14, 2009

Related U.S. Application Data
(60) Provisional application No. 61/199,266, filed on Nov. 14, 2008.

(51) Int. Cl. B60P 1/64

(52) U.S. Cl. 410/82

(57) ABSTRACT

A twistlock having an increased tension load limit that is based on a physical configuration that has a massive amount of material removed from the shaft of the twistlock. Two parallel, circular cross-section rabbets are cut at the intersection of the shoulder of the truncated conical extension formed at one end of the shaft that forms the twistlock. The tensional loading limit in this configuration is greatly enhanced.

This application incorporates herein by reference and claims under 35 U.S.C. 119, the right of priority and the benefit of earlier filing date of provisional application No. 61/199,266 filed Nov. 14, 2008. Both this application and the provisional application have the same inventors.

### BACKGROUND OF THE INVENTION

The present invention relates to an improved twistlock as is commonly found in the craning industry, that is able to withstand higher levels of tensile loading without failure, than the prior art twistlocks.

Twistlocks are mechanical devices that are used in the craning industry to connect lift beams to the corner castings of a container box. These oblong bodied lifting devices are inserted through the oblong hole in the steel corner plates of a cargo box and twisted 90° such that the weight of the cargo box is placed onto the shoulders of the four twistlocks as the crane raises the lifting beam.

The physical configuration of a twistlock is that of a shaft that is threaded an a proximate end and has a conical extension formed at its distal end. In tensile failure, a crack develops at the junction of the shoulder of the conical extension and the shaft and propagates quickly across the thickness of the shaft, thereby tearing the conical extension off of the shaft.

To reduce the stresses and strengthen the twistlock the prior art has utilized a few different solutions. One solution incorporates a beveled ring or web of material that resides atop the extension at the junction of the conical extension's shoulder and the shaft. This looks similar to that of a circular fillet weld and is intended to add structural strength at the common point of crack development and propagation. Another solution incorporates a small annular groove cut at the junction of the extension's shoulder and the shaft as a form of stress relief. This is designed to increase the surface area therein reducing the amount of stress per unit surface area in the crack propagation zone.

The current invention goes against all conventional and obvious solutions presented in the prior art. It cuts two parallel, circular cross-section rabbets through the shaft and the extension at the intersection of the shoulder and the shaft. These rabbets are deep in proportion to the diameter of the shaft. Finite element analysis comparisons between prior art twistlocks and the improved twistlock of the present invention have shown that the improved twistlock can withstand almost twice the tensional stress before failure than conventional twistlocks.

Henceforth, an improved twistlock, that is able to withstand higher levels of tensile loading without failure, would fulfill a long felt need in the craning industry. This new invention utilizes and combines known and new technologies in a unique and novel configuration to overcome the aforementioned problems and accomplish this.

### SUMMARY OF THE INVENTION

The general purpose of the present invention, which will be described subsequently in greater detail, is to provide an improved twistlock that is able to endure higher tensional loads before failure.

It has many of the advantages mentioned heretofore and many novel features that result in a new twistlock configuration which is not anticipated, rendered obvious, suggested, or even implied by any of the prior art, either alone or in any combination thereof.

In accordance with the invention, an object of the present invention is to provide an improved twistlock capable of being formed from existing twistlocks by simple inexpensive mechanical procedures.

It is another object of this invention to provide an improved twistlock capable of meeting or exceeding current industry standards in twistlock tensile loading.

It is a further object of this invention to provide an improved twistlock that can be simply fabricated.

It is a final object of this invention to reduce the maximum tension stresses experienced by a twistlock and extend the twistlock's safe service life. Reduction of these high tension stresses will reduce or eliminate detectable cracks and minimize a major operating expense for container handling maintenance labor and replacement parts.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is a front view of a prior art twistlock;

FIG. 2 is a side view (rotation of 90° from the front view) of a prior art twistlock;

FIG. 3A is a front view of the lifting protuberance of the improved twistlock before the stress relief straight cuts have been made;

FIG. 3B is a side view of the lifting protuberance of the improved twistlock before the stress relief straight cuts have been made;

FIG. 3C is a front cross-sectional view of the lifting protuberance of the improved twistlock before the stress relief straight cuts have been made;

FIG. 3D is a top view of the lifting protuberance of improved twistlock before the stress relief straight cuts have been made;

FIG. 4 is a side view of the improved twistlock;

FIG. 5 is a front view of the improved twistlock;

FIG. 6 is a top view of the improved twistlock;

FIG. 7 is a bottom view of the improved twistlock;

FIG. 8 is a cross-sectional view of the improved twistlock;

FIG. 9 is a perspective view of the improved twistlock; and

FIG. 10 is a perspective view of the lifting protuberance of the improved twistlock with arrows indicating stress tensors.

### DETAILED DESCRIPTION

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

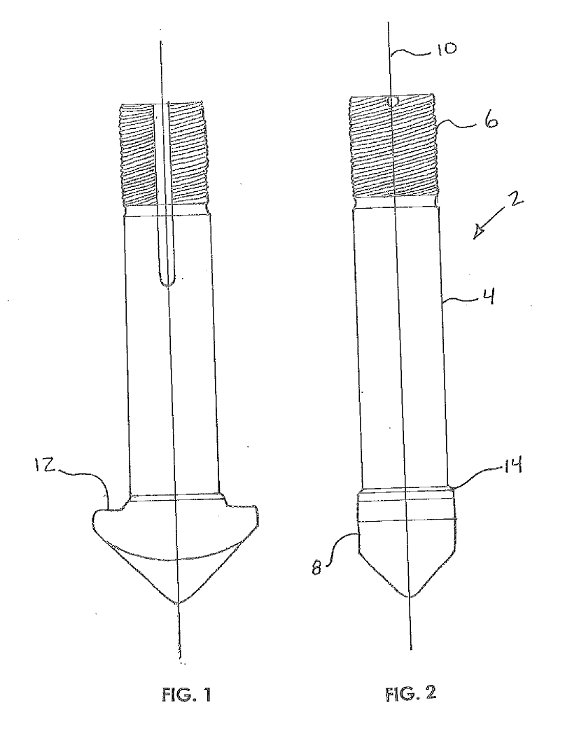

Twistlocks are mechanical lifting devices used in the container industry for lifting containers and also for lifting the spreader beams that in turn lift containers. A twistlock connects into a housing that has an elongated hole. The twistlock is inserted with its conical projection or T-head in line with the long direction of the hole. The twistlock is then turned 90° to engage the twistlock housing. Twistlock housings are installed at the corners of all ISO marine shipping containers. They are also installed topside on the spreader beams to provide pick points for the device that lifts the spreader beam. FIG. 1 and FIG. 2 show prior art examples of twistlocks. Conventional twistlocks 2 are cylindrical shafts 4 that have engageable threads 6 formed on a proximate (top) end and a lifting protuberance 8 formed on a distal(bottom) end. The lifting protuberance 8 is configured generally as a cone that has been sectioned by two planes that reside parallel to each other and to the longitudinal axis 10 of the shaft 4. The minimum thickness of the protuberance 8 exceeds the maximum thickness of the shaft 4. Two identical conic sections are formed on the planar sides of the protuberance. The planar base of the protuberance forms a shoulder 12 that resides perpendicular to the longitudinal axis 10 of the shaft. A chamfer 14 transitions the shoulder 12 to the shaft 4 at their junction. The chamfer 14 is designed to reduce the point stress loading at this junction. This design is typical of the stress relief concepts that are conventional mechanical engineering practice. When under tension, conventional twistlocks 2 fail at this shoulder/shaft junction. A stress crack propagates on the chamfer 14 and travels across the shaft 4, parallel to the shoulder 12 until the protuberance 8 is torn from the shaft 4.

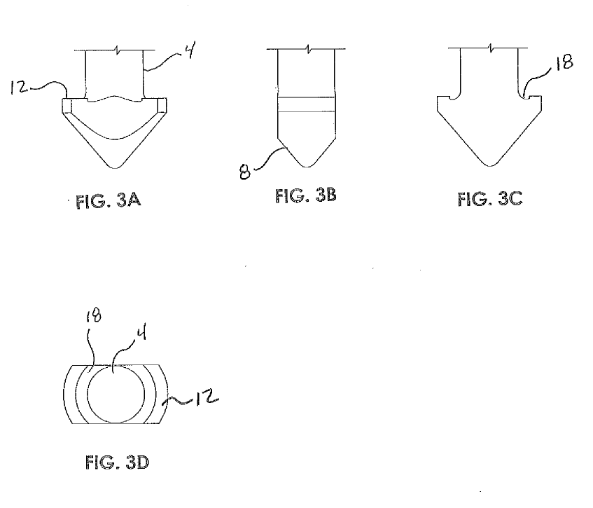

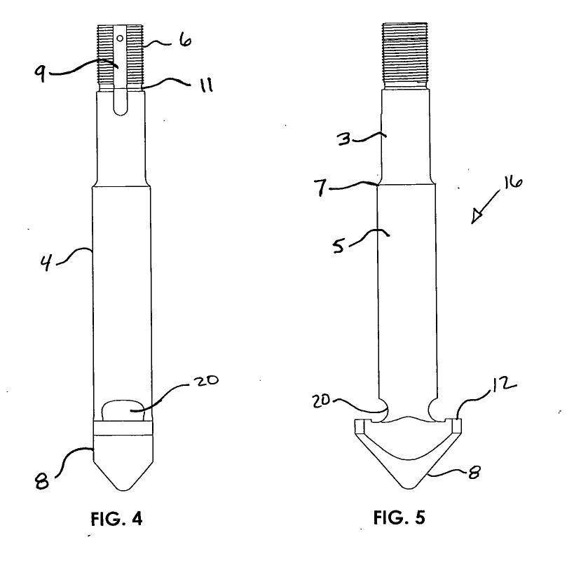

The improved twistlock 16 can best be explained with reference to FIGS. 4-5. The improved twistlock has a very similar physical configuration to the conventional twistlock 2. Shaft 4 comprises at least two different diameter portions 3 and 5 divided by a transition zone 7. An operating grove 9 runs along a portion of shaft 4 and an annular groove 11 is formed around its circumference for attachment to a locking means. The critical differences between the conventional twistlock (prior art) and the improved twistlock 16 of the present invention occur at the junction of the shoulder 12 and the shaft 4. The preferred embodiment utilizes an 81° 1′ cone taper with a 4.3310 inch shoulder length. A circumferential stress relief groove 18 is cut on the shoulder 12 at a uniform distance from the shaft 4. (See FIGS. 3C and 9) In the preferred embodiment with a 2.3820 inch-2.342 inch thick shaft 4, this circular stress relief groove 18 is 0.1250 inch deep with an edge radius of 0.0625 inches and extends to a distance of 0.3125 inches from the edge of the shaft 4. FIGS. 3A-3D are different views of the lifting protuberance 8 of the improved twistlock 16 with the stress relief groove 18, but before the stress relief cuts 20 have been made. There are two parallel stress relief straight cuts 20 that reside perpendicular to the protuberance's planar sides 22. These cuts are equidistant from the linear axis of the shaft 4. The straight cuts 20 are circular in cross-section and begin at the bottom of the circular stress relief groove 18 extending across the shaft 4. In the preferred embodiment these straight cuts have a radius of 0.5 inches and extend 0.3750 inches into the shaft 4.

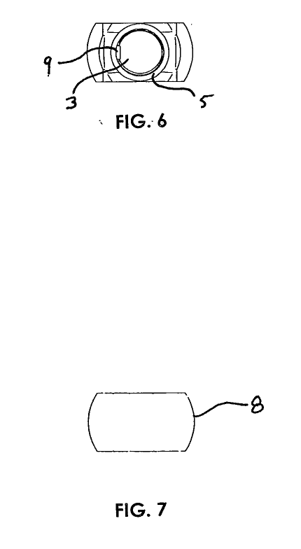

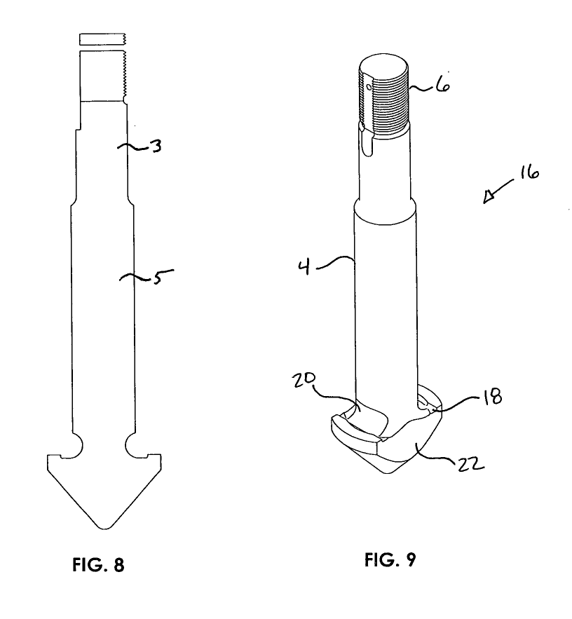

Looking at FIGS. 8 and 9, cross-sectional view and a perspective view of the improved twistlock 16, respectively, the orientation of the stress relief groove 18 and the stress relief straight cut 20 with respect to the shaft 4 and the protuberance's planer sides 22 can be seen. Additionally, FIG. 6 provides a top view of improved twistlock 16, i.e., looking straight down shaft 4 towards lifting protuberance 8, and FIG. 7 provides a bottom view of improved twistlock 16, i.e., looking straight up under lifting protuberance 8 towards shaft 4.

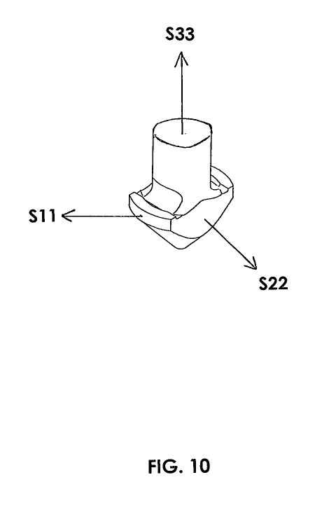

All of the above dimensions were arrived at through physical experimentation and finite analysis comparisons. Dimensional changes were made and the amount of applied tension to failure was charted. Looking at Table 1, the maximum Von Mises (VM) stress of 112.2 ksi for a prior art conventional twistlock is almost double the 68.3 ksi for the improved twistlock of the present invention. S11, S22, and S33 (See FIG. 10) are triaxial tension stresses that occur at the same place as the maximum VM stress. The more these stresses are equal to each other the more “brittle” the material behaves. For each of the twistlocks (prior art and improved), comparing the ratios of S11 to S22 and to S33 gives an indication of how brittle the material will appear to be after it is initially cracked. It can be seen that the improved twistlock is considerably more ductile that the conventional twistlock under load. The results of the equivalent tensile stress (scalar stress values computed from the stress tensors) are as follows:

TABLE 1

| | Maximum Von Mises and | | | | |
|---|---|---|---|---|---|
| | Corresponding Tensors | | | | |
| Twist lock | Max. Von | S11 | S22 | S33 | S31 |
| Type | Mises (ksi) | (ksi) | (ksi) | (ksi) | (ksi) |
| Prior Art | 112.2 | 96.3 | 42.3 | 94.2 | 59.1 |
| Improved | 68.3 | 68.8 | 17.8 | 47.5 | 34.5 |
| (present | | | | | |
| invention) | | | | | |

The advantages of changing the protuberance (T-head) design can be seen when comparing the linear static stress profiles of Table 1. Here the same operating load is applied to both the conventional (standard) twistlock and the improved twistlock 16 over the same contact area. The VM stress depictions for the two twistlocks.

The primary effect accomplished by the use of the stress relief straight cuts 20 is a large reduction in the maximum tension stresses. When viewing a Linear Static Stress Model of the a prior art twistlock, the high stress “hot spot” is a very small area occurring at the junction fo the shoulder 12 and the shaft 4, indicating that the main load path is through a very small area. When viewing a Linear Static Stress Model of the improved twistlock of the present invention the high stress “hot spot” is spread out over a comparatively large area to that of a prior art twistlock, indicating the main load path is through a relatively large area compared to that of the conventional twistlock's load path. The large stress reduction was accompanied by the removal of a large percentage of the shaft's cross-section area, which goes against the usual industry practice. It is counter intuitive that such large stress relief cuts could reduce the maximum tension stress compared to conventional stress relief details. Straight cut 20 could be defined as a cut that is straight across or has a cross-radius much larger than the shaft radius. The crossing radius center is parallel to the shaft 4 at a very large distance away.

As stated earlier, the physical configuration of the improved twistlock is counter intuitive given the large amount of steel that is machined away from the interior of the shaft 4 to accommodate the stress relief straight cuts 20. In the testing phase, small amounts of material were continually removed from the shoulder/shaft junction as long as the maximum VM stress decreased. Once the Von Mises stress increased this was considered the optimum cut. This optimum cut turned out to provide a stress ratio of 1.0 for the governing specified load.

It is to be noted that although the preferred embodiment cites actual dimensions, it is the ratio of certain dimensions to each other that is important, not the actual dimensions. The individual twistlocks are designed to handle a lifted load that depends on the weights of the loaded container and associated crane's spreader beam that is to be used. The twistlock shaft cross-sectional area is proportioned to the load. The protuberance (T-head) sizes are somewhat standardized in the container industry because the housing size has to be compatible with container industry standards.

TABLE 2

| | | | | Cone Arc |
|---|---|---|---|---|
| Shaft | Bore Diameter | Shaft Bore | Cone Bore | Depth/ |
| Diameter | (Relief Cut) | Depth | Depth | Edge Radius |
| 2.3820 | .500 | .375 | .125 | 0.125/.0625 |
| | % of Shaft | % of Shaft | % of Shaft | % of Shaft |
| | Diameter | Diameter* | Diameter | Diameter |
| | 21% | 31.50% | 5.25% | 5.25%/2.62% |

*Approximately 68.5% if the shaft's diameter remains at the thinnest part of the shaft.

Looking at the values in TABLE 2 it can be seen that the stress relief straight cuts 20 are machined out sections corresponding to a 1 inch diameter bore that extends ⅜ of an inch into the shaft 4 and ⅛ of an inch into the shoulder 12 as referenced from the junction point of the shoulder 12 and the shaft 4. The radius of the bore is approximately 21% of the shaft diameter with both stress relief straight cuts 20, 31.5% of the shaft's diameter is removed.

It is expected that optimal design for stress relief with the disclosed invention will reside within 25% of the ratios stated.

In conjunction with the new design of the improved twistlock, the life of the twistlock can be enhanced by applying durable but removable corrosion protection on the critical areas of the twistlock between NDT exams; installing a ½ inch thick Fabreeka® resilient laminated fabric pad sandwiched between steel plate washers under the nut to cushion shock loads.

Other types of pads suited for the reduction of impact shock, vibration and structure-borne noise and that meet Military specification MIL-C-882E would be acceptable. The pad size depends on available space. Additionally, if there is a spherical bearing at the top of the twistlock, enlarge any restrictions so the twistlocks can swivel more when the headlock is loaded laterally. This will help reduce the effect of operational loads that have not been specified, and may be causing shoulder/shaft junction cracks.

The above description will enable any person skilled in the art to make and use this invention. It also sets forth the best modes for carrying out this invention. There are numerous variations and modifications thereof that will also remain readily apparent to others skilled in the art, now that the general principles of the present invention have been disclosed. As such, those skilled in the art will appreciate that the conception, upon which this disclosure is based, may readily be utilized as a basis for the designing of other structures, methods and systems for carrying out the several purposes of the present invention. It is to be noted that the preferred embodiment design depicts a straight cut because of the fabrication difficulties encountered when attempering a annular cut. The straight cut version disclosed is just an example of an infinite radius condition. A similar cut slightly curving into the shaft or slightly curving away from the shaft would have similar stress reduction effects. It is important, therefore, that the claims be regarded as including such equivalent constructions insofar as they do not depart from the spirit and scope of the present invention.

Having thus described the invention, what is claimed as new and desired to be secured by Letters Patent is as follows:

1. A twistlock comprising a cylindrical shaft with a solid cone formed at a first end of said shaft, wherein said cone is intersected and sectioned by two parallel conics that lie in planes that also reside parallel to a longitudinal axis of said shaft, and wherein a ring trough is formed at an interface of said cone and said shaft and two parallel rabbets are cut into said shaft at the interface of said cone and said shaft.

2. The twistlock of claim 1 wherein said rabbets have a semi-circular cross-section.

3. The twistlock of claim 1 wherein said rabbets partially intersect said ring trough.

4. The twistlock of claim 2 wherein said rabbets partially intersect said ring trough.

5. A twistlock for engagement with a container box comprising:
a cylindrical shaft having a proximate threaded end and a distal end having a conical projection formed thereon;
wherein said conical projection has a vertex and a generally planar base extending normally therefrom the complete distal end of said shaft such that a longitudinal axis of said conical projection is aligned with said longitudinal axis of said shaft and,
two parallel, stress relief rabbets formed through said shaft and said conical projection at the intersection of said base of said conical projection and said shaft.

6. The twistlock of claim 5 wherein said rabbets have a semi circular cross-section.

7. The twistlock of claim 5 further comprising a stress relief ring groove formed about an intersection of said base of said conical projection and said shaft.

8. The twistlock of claim 7 wherein said stress relief ring groove has a semi-circular cross-section.

9. The twistlock of claim 6 further comprising a stress relief ring groove formed about an intersection of said base of said conical projection and said shaft.

10. The twistlock of claim 9 wherein said stress relief ring groove has a semi-circular cross-section.

11. The twistlock of claim 6 wherein said rabbets partially intersect said ring groove, and reside perpendicular to said ring groove.

12. The twistlock of claim 7 wherein said rabbets partially intersect said ring groove, and reside perpendicular to said ring groove.

13. The twistlock of claim 8 wherein said rabbets partially intersect said ring groove, and reside perpendicular to said ring groove.

14. The twistlock of claim 9 wherein said rabbets partially intersect said ring groove, and reside perpendicular to said ring groove.

15. The twistlock of claim 5 wherein said conical projection is solid and said vertex is rounded.

16. A twistlock for engagement with a container box comprising:
a stepped diameter cylindrical shaft having a proximate threaded end with at least one surface retention slot residing parallel to a longitudinal axis of said shaft formed thereon and a distal end having a solid conical projection formed thereon;
wherein said solid conical projection has a rounded vertex and a generally planar base extending normally therefrom the complete distal end of said shaft such that a longitudinal axis of said conical projection is aligned with said longitudinal axis of said shaft and wherein intersected and sectioned by two parallel conics that lie in planes that also reside parallel to a longitudinal axis of said shaft;
a semi-cylindrical cross-section stress relief ring groove formed about an interface of said base of said conical projection and said shaft;
two parallel, semi circular cross-section stress relief rabbets formed through said shaft and said conical projection at the interface of said base of said conical projection and said shaft, such that said rabbets partially intersect said ring groove, and reside perpendicular to said ring groove.
